(19) United States
(12) Patent Application Publication
(10) Pub. No.: US 2025/0148426 A1
(43) Pub. Date: May 8, 2025

(54) A SYSTEM AND A METHOD FOR DETERMINING A MOUNTING PATTERN OF A PLURALITY OF LED LUMINAIRES

(71) Applicant: SIGNIFY HOLDING B.V., EINDHOVEN (NL)

(72) Inventors: FRANCISCUS ANTONIUS VAN DEN BERG, EINDHOVEN (NL); DZMITRY VIKTOROVICH ALIAKSEYEU, EINDHOVEN (NL)

(21) Appl. No.: 18/833,446

(22) PCT Filed: Jan. 23, 2023
(86) PCT No.: PCT/EP2023/051579

§ 371 Date: Jul. 26, 2024

(30) Foreign Application Priority Data
Jan. 28, 2022 (EP) 22153797.0

(51) Int. Cl. G06Q 10/20; G06Q 10/04; H05B 47/20

(52) U.S. Cl. CPC G06Q 10/20; G06Q 10/04; H05B 47/20

(57) ABSTRACT

A system (1) for determining a mounting pattern of a plurality of LED luminaires (10) comprising second-hand LED luminaires that have been retrieved from one or more previous lighting environments, the system (1) comprising a memory unit (2) and a processor (3), the processor being configured to obtain data comprising at least a used lifetime of each LED luminaire (11, 12, 13, 14) of a plurality of LED luminaires (10) and store the obtained data in the memory unit (2), determine, from the obtained data (5), at least one of the used lifetime and a remaining expected lifetime of each LED luminaire (11, 12, 13, 14), determine a mounting pattern (6) of the plurality of LED luminaires (10), and outputting the determined mounting pattern (6). The mounting pattern (6) comprises at least one of one or more groups (61, 62) of LED luminaires being determined based on the determined one of the used lifetime and the remaining expected lifetime of each LED luminaire (11, 12, 13, 14), and at least one location in which to install the one or more groups (61, 62) of LED luminaires, the at least one location being based on the determined one of the used lifetime and the remaining expected lifetime of each LED luminaire (11, 12, 13, 14).

### FIELD OF THE INVENTION

The invention relates to a system and a method for determining a mounting pattern of a plurality of LED luminaires comprising second-hand LED luminaires that have been retrieved from one or more previous lighting environments.

As used herein, the term “second-hand LED luminaire” is intended to refer to a LED luminaire which has been retrieved from a previous lighting environment, and which therefore has already been used for a period of time. Such a second-hand LED luminaire thus comprises a used lifetime being larger than zero hours and an expected remaining lifetime being correspondingly smaller than the expected lifetime of an identical new and unused LED luminaire.

As used herein, the term “mounting pattern” is intended to mean any feasible pattern in which a plurality of LED luminaires, particularly a plurality of LED luminaires which have not been mounted or installed, may be mounted or installed, including patterns within one and the same location and patterns distributed over two or more mutually separate locations.

As used herein, the term “location” is intended to mean any feasible place or position in which a LED luminaire, or a plurality of LED luminaires, may be mounted or installed. In this connection, a location may for instance both be a place such as a room, a building, an outdoor space or a thoroughfare and a more specific position within or forming a part of such a place.

As used herein, the term “compile” is intended to mean to produce, e.g., a list or a database, by assembling information collected from various sources.

### BACKGROUND OF THE INVENTION

Due to sustainability and circularity goals set by retailers and upcoming legislation, particularly EU legislation, the demand for repairable luminaires and the use of second-hand luminaries is expected to grow.

Renovation cycles of food retail stores are between 7-10 years. Also, it is becoming more common to refresh a part of a store frequently, often every 2-3 years. In connection with renovations and refreshments, the desire to re-use materials/furnishings from the old store or building is increasing and will become the standard, driven by shortages, increased costs, and sustainability demands.

LED luminaires that have been retrieved from a previous store environment have still got value. As newly installed such LED luminaires typically have 10-12 years of burning hours. This means that at the time of renovating or refreshing the store these LED luminaires still have some years of lifetime left, and it is thus desirable to exploit this left over lifetime by installing the retrieved LED luminaires anew in a renovated or refreshed store.

However, the left over lifetime of the retrieved LED luminaires is not long enough to last a full new renovation cycle in the store. For instance, the LED luminaires may have 3-5 years of lifetime left as compared to a renovation cycle of 7-10 years. This will lead to more frequent failures and more frequent need for repair.

Furthermore, some retrieved LED luminaires that become available after a store renovation (long term) or refreshment (short term) still have years of burning hours to go, while other retrieved LED luminaires are almost at their end-of-life and will on a shorter term need a replacement of the light output module. Therefore, there will often be a mix of retrieved LED luminaires with respect to burning hours remaining. This will have the effect that repairs or replacements will need to happen even more frequently.

US 2017/0013698 A1 discloses a streetlight management system with which already mounted streetlights can be automatically grouped with the aim of facilitating easy and efficient maintenance. The automatic grouping can be determined based on various geographical parameters, such as the position or place in which the streetlights are mounted, as well as various measured parameters including lamp life. The streetlight management system may include a maintenance history screen, which may comprise a list of actions performed on a streetlight controller and corrective action information. The corrective action information can include end of life predictions, and the streetlight management system may display a burn hour report for one or more streetlight controllers, based on which repairs may be scheduled to for instance include exchange of luminaires close or next to a luminaire to be exchanged provided that the remaining time until the predicted end of life of such luminaires is sufficiently short.

However, this streetlight management system does not take into account how to mount or install LED luminaires, whether new or second-hand, in a new location. Furthermore, this streetlight management system does not take into account the possibility of using retrieved second-hand LED luminaires. Also, this streetlight management system does not fully exploit the remaining lifetime of new luminaires and second-hand luminaires alike.

It is therefore desired to provide a system and a method enabling improved exploitation of remaining lifetime of second-hand LED luminaires, thus encouraging recycling of such LED luminaires.

It further desired to provide such a system and method facilitating mounting LED luminaires, and particularly second-hand LED luminaires that have been retrieved from a previous lighting environment, with which the need for repair is reduced, such that the time and costs spent on repairs may be kept to a minimum, particularly for the retailer, and with which it further becomes possible for workers installing the LED luminaires to complete installation in a fast and efficient manner, such that the costs for installation will be kept to a minimum, particularly for the retailer.

### SUMMARY OF THE INVENTION

It is an object of the present invention to overcome the above problems and to provide a system and a method enabling improved exploitation of remaining lifetime of second-hand LED luminaires, thus encouraging recycling of such LED luminaires.

It is a further object of the invention to provide a system and a method for facilitating mounting new LED luminaires and especially second-hand LED luminaires that have been retrieved from a previous lighting environment with which the need for subsequent repair is reduced, such that the time and costs spent on repairs may be kept to a minimum.

It is a still further object of the invention to provide such a system and method with which it further becomes possible for workers installing the LED luminaires to complete installation in a fast and efficient manner, such that the costs for installation will be kept to a minimum.

According to a first aspect of the invention, this and other objects are achieved by a system for determining a mounting pattern of a plurality of LED luminaires comprising second-hand LED luminaires that have been retrieved from one or more previous lighting environments, the system comprising a memory unit and a processor, the processor being configured to obtain data comprising at least a used lifetime of each LED luminaire of a plurality of LED luminaires and store the obtained data in the memory unit, determine, from the obtained data, at least one of the used lifetime and a remaining expected lifetime of each LED luminaire of the plurality of LED luminaires, determine a mounting pattern of the plurality of LED luminaires, the mounting pattern being a pattern in which the plurality of LED luminaires may be mounted or installed, the mounting pattern comprising i) one or more groups of LED luminaires, the one or more groups of LED luminaires being determined based on the determined one of the used lifetime and the remaining expected lifetime of each LED luminaire of the plurality of LED luminaires, and ii) at least one location in which to install the one or more groups of LED luminaires, the at least one location being based on the determined one of the used lifetime and the remaining expected lifetime of each LED luminaire of the respective group of the one or more groups of LED luminaires, such that LED luminaires with similar used lifetime and/or remaining expected lifetime are identified and installed in the same location, and outputting the determined mounting pattern. The mounting pattern may be indicative of a physical arrangement of the plurality of luminaires. That is, the mounting pattern comprises one or more groups of LED luminaires for which a difference in the determined one of the used lifetime and the remaining expected lifetime of each LED luminaire of the plurality of LED luminaires is below a threshold and at least one location in which to install the one or more groups of LED luminaires such that groups of LED luminaires for which a difference threshold in the determined one of the used lifetime and the remaining expected lifetime of each LED luminaire of the plurality of LED luminaires is below a threshold are installed in the same location. The system may thus be operated with the one or more groups of LED luminaires (installed) mounted in the new locations. Thereby, and in particular by providing that a mounting pattern in which the plurality of LED luminaires may be mounted or installed is determined such that it comprises at least one of the above-described two components, a system for determining a mounting pattern of a plurality of LED luminaires comprising second-hand LED luminaires that have been retrieved from one or more previous lighting environments is provided with which mounting or installing new LED luminaires and second-hand LED luminaires that have been retrieved from a previous lighting environment alike is facilitated, especially such that the need for subsequent repair is reduced, and such that the time and costs spent on repairs may be kept low or to a minimum.

Furthermore, such a mounting pattern makes it possible for workers installing the LED luminaires to complete installation in a fast and efficient manner, such that the costs for installation will be kept to a minimum.

Thus, such a system enables improved exploitation of remaining lifetime of second-hand LED luminaires, while keeping repair and installation costs low, thereby encouraging recycling of second-hand LED luminaires.

Further, such a system is especially advantageous when installing and maintaining lighting in retail stores and the like, since it ensures that retailers experience the least possible disturbance in store, caused by failing lighting, and that installers can work as efficient as possible, lowering costs and time spent for repairs/replacements.

In an embodiment, the processor is further configured to determine at least one location in which to install each of the one or more groups of LED luminaires based on the obtained one of the used lifetime and the remaining expected lifetime of each LED luminaire of the respective group of the one or more groups of LED luminaires.

Thereby, a mounting pattern in which the plurality of LED luminaires may be mounted or installed is determined in such a way that it combines the above-described two components, namely groups and location, such as to provide a determined mounting pattern being particularly exact and especially enabling grouping LED luminaires with similar past use together. Thus, not only is the need for subsequent repair is reduced even further, but workers installing the LED luminaires are also enabled to complete installation in a particularly fast and efficient manner.

In an embodiment, the processor is configured to further base the determination of the at least one location in which to install the one or more LED luminaires or each of the one or more groups of LED luminaires on one or more of an expected renovation or refreshment time for the location, and ease or difficulty of installing or changing the luminaire in the location.

Thereby, the need for subsequent repair is reduced even further, such that the time and costs spent on repairs may be kept to a minimum. Furthermore, maintenance, and especially predictive maintenance, is in this way simplified considerably.

In an embodiment, the obtained data further comprises a remaining expected lifetime of the plurality of LED luminaires.

Thereby, the obtained data forming basis for the determined mounting pattern becomes more detailed and exact, thus improving the determined mounting pattern.

In an embodiment, the obtained data comprises information retrieved from a code provided on each LED luminaire of the plurality of LED luminaires, the code indicating at least one of a used lifetime and a remaining expected lifetime.

Thereby, the data may be obtained and may be kept updated in a particularly simple manner while also ensuring that the obtained data is unique for every LED luminaire. Furthermore, the data may be obtained without the need for calculations or estimations by the processor, thus saving processing power and memory usage, especially read access memory usage. Still further, such a code, and thus the data to be obtained, may be updated periodically or continuously in a particularly simple manner.

In an embodiment, the system further comprises a reading device, and the system is configured to read, by the reading device, a code provided on each LED luminaire of the plurality of LED luminaires, the code indicating at least one of a used lifetime and a remaining expected lifetime.

Thereby, the data may be obtained in a particularly simple and efficient manner.

In an embodiment, processor is further configured to obtain the data by for each LED luminaire of the plurality of LED luminaires providing at least one of a modeled used lifetime and a modeled remaining expected lifetime, the at least one of a modeled used lifetime and a modeled remaining expected lifetime being provided based on a usage pattern of the LED luminaire and on environmental parameters.

Thereby, the data may be obtained, and especially the obtained data may be kept updated, periodically or continuously, in a particularly simple and efficient manner.

In an embodiment, the processor is further configured to perform a periodic assessment of each LED luminaire of the plurality of LED luminaires, and based on the assessment provide recommendation as to at least one of which groups require new LED luminaires and in which locations second-hand LED luminaires could be still used based on the prevailing conditions.

Thereby, a system is provided with which it becomes possible to recommend both which areas require new LED luminaires and in which part of a location old LED luminaires could be still used based on the conditions, importance and ease of installation and repair. For instance, older LED luminaires will require repairs sooner and should advantageously be located in easily accessible areas.

In an embodiment, the processor is further configured to identify, based on the determined at least one of the used lifetime and the remaining expected lifetime of each LED luminaire of the plurality of LED luminaires, the second-hand LED luminaires amongst the plurality of LED luminaires, and to determine the mounting pattern of the plurality of LED luminaires or each of the one or more groups of LED luminaires based on the determined one of the used lifetime and the remaining expected lifetime of each LED luminaire of the plurality of LED luminaires as well as the identified second-hand LED luminaires.

Thereby, a system is provided with which it becomes possible to ensure that LED luminaires with similar past use data may be identified and installed in the same location/zone or area in a particularly simple manner.

In an embodiment, the processor is further configured to output the determined mounting pattern by any one or more of: presenting the determined mounting pattern on a display of the system, storing the determined mounting pattern in the memory unit, storing the determined mounting pattern in a memory unit being external to the system, and providing installation instructions based on the determined mounting pattern.

Presenting the determined mounting pattern on a display of the system or providing installation instructions based on the determined mounting pattern provides the worker, particularly an electrician, with an easy to follow plan for installing the plurality of LED luminaires.

Storing the determined mounting pattern in a memory unit, whether internal or external to the system, provides for easy access to the mounting pattern at a later stage, for instance if the actual installation procedure is to be undertaken at a later point in time or takes more than one working day, or simply for reference.

In an embodiment, the processor is further configured to compile the obtained data, for instance into a list or a database, and store the compiled data in the memory unit.

Thereby, simplified access to the obtained data is provided for, for instance during determination of the mounting pattern or if it is desired to take into account the data history or parts thereof at a later stage.

According to a second aspect of the invention, the above and other objects are achieved by a computer implemented method for determining a mounting pattern of a plurality of LED luminaires comprising second-hand LED luminaires that have been retrieved from one or more previous lighting environments, the method comprising by a computer processor: obtaining data comprising at least a used lifetime of each LED luminaire of a plurality of LED luminaires and store the obtained data in a memory unit, determining, from the obtained data, at least one of the used lifetime and a remaining expected lifetime of each LED luminaire of the plurality of LED luminaires, determining a mounting pattern of the plurality of LED luminaires, the mounting pattern being a pattern in which the plurality of LED luminaires may be mounted or installed, the mounting pattern comprising at least one of: i) one or more groups of LED luminaires, the one or more groups of LED luminaires based on the determined one of the used lifetime and the remaining expected lifetime of each LED luminaire of the plurality of LED luminaires, and ii) at least one location in which to install the one or more LED luminaires, the at least one location being based on the determined one of the used lifetime and the remaining expected lifetime of each LED luminaire of the plurality of LED luminaires, and outputting the determined mounting pattern.

In an embodiment, the method further comprises by the computer processor determining at least one location in which to install each of the one or more groups of LED luminaires based on the obtained one of the used lifetime and the remaining expected lifetime of each LED luminaire of the respective group of the one or more groups of LED luminaires.

In an embodiment, determining the at least one location in which to install the one or more LED luminaires or each of the one or more groups of LED luminaires is furthermore based on one or more of an expected renovation or refreshment time for the location, and ease or difficulty of installing or changing the luminaire in the location.

In an embodiment, obtaining data comprises obtaining data further comprising a remaining expected lifetime of the plurality of LED luminaires.

In an embodiment, obtaining data comprises retrieving information from a code provided on each LED luminaire of the plurality of LED luminaires, the code indicating at least one of a used lifetime and a remaining expected lifetime.

In an embodiment, determining, from the obtained data, the at least one of the used lifetime and the remaining expected lifetime of each LED luminaire of the plurality of LED luminaires comprises, by the computer processor, reading the codes of the LED luminaires of the plurality of LED luminaires.

In an embodiment, obtaining data comprises, for each LED luminaire of the plurality of LED luminaires, providing at least one of a modeled used lifetime and a modeled remaining expected lifetime, wherein the at least one of a modeled used lifetime and a modeled remaining expected lifetime are provided based on a usage pattern of the LED luminaire and on environmental parameters.

In an embodiment, the method further comprises, by the computer processor, performing a periodic assessment of the at least one of a used lifetime and a remaining expected lifetime of each LED luminaire of the plurality of LED luminaires, and based on the assessment provide recommendation as to at least one of which groups require new LED luminaires and in which locations second-hand LED luminaires could be still used based on the prevailing conditions.

In an embodiment, the method further comprises, by the computer processor, identifying, based on the determined at least one of the used lifetime and the remaining expected lifetime of each LED luminaire of the plurality of LED luminaires, the second-hand LED luminaires amongst the plurality of LED luminaires and determining the mounting pattern of the plurality of LED luminaires or each of the one or more groups of LED luminaires based on the determined one of the used lifetime and the remaining expected lifetime of each LED luminaire of the plurality of LED luminaires as well as the identified second-hand LED luminaires.

In an embodiment, the method further comprises, by the computer processor, outputting the determined mounting pattern by any one or more of: presenting the determined mounting pattern, storing the determined mounting pattern in a memory unit, and providing installation instructions based on the determined mounting pattern.

In an embodiment, the method further comprises, by the computer processor, compiling the obtained data and store the compiled data in the memory unit.

It is noted that the invention relates to all possible combinations of features recited in the claims.

### BRIEF DESCRIPTION OF THE DRAWINGS

This and other aspects of the present invention will now be described in more detail, with reference to the appended drawings showing embodiment(s) of the invention.

FIG. 1 shows a perspective view of a plurality of luminaires for which a mounting pattern is to be determined.

FIG. 2 shows a schematic diagram of a system according to the invention.

FIG. 3 shows a flow diagram illustrating a method according to the invention.

FIG. 4 shows a flow diagram illustrating further possible steps of a method according to the invention.

FIG. 5 shows a flow diagram illustrating further possible steps of a method according to the invention.

FIG. 6 shows a flow diagram illustrating possible steps involved in obtaining data to be used by a system according to the invention and in a method according to the invention.

### DETAILED DESCRIPTION

The present invention will now be described more fully hereinafter with reference to the accompanying drawings, in which currently preferred embodiments of the invention are shown. This invention may, however, be embodied in many different forms and should not be construed as limited to the embodiments set forth herein; rather, these embodiments are provided for thoroughness and completeness, and fully convey the scope of the invention to the skilled person.

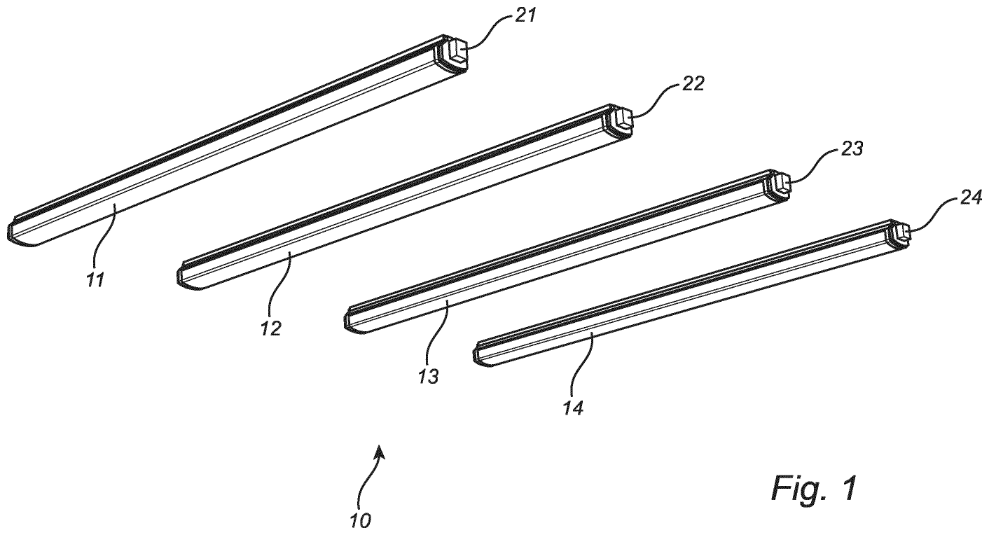

FIG. 1 shows a plurality of LED luminaires 10. By way of example four LED luminaires 11, 12, 13, 14 are shown in FIG. 1, although in principle any number of LED luminaires may be comprised in the plurality of LED luminaires 10. The plurality of LED luminaires 10 may comprise second-hand LED luminaires that have been retrieved from one or more previous lighting environments, new LED luminaires which have not yet been used or a combination thereof. The LED luminaires 11, 12, 13, 14 of the plurality of LED luminaires 10 may be any type of LED luminaire. The LED luminaires 11, 12, 13, 14 of the plurality of LED luminaires 10 may be of the same type or of two or more different types.

Some or all of the LED luminaires 11, 12, 13, 14 may comprise a code 21, 22, 23, 24. The respective code 21, 22, 23, 24 may indicate a used lifetime of the associated respective LED luminaire 11, 12, 13, 14, a remaining expected lifetime of the associated respective LED luminaire 11, 12, 13, 14 or both. The code 21, 22, 23, 24 may be configured to be updated or changed periodically or continuously to reflect the used lifetime of the associated respective LED luminaire 11, 12, 13, 14, the remaining expected lifetime of the associated respective LED luminaire 11, 12, 13, 14 or both at pre-defined time-intervals or at any given time during the life-time of the LED luminaire 11, 12, 13, 14.

It is noted that when referring to a LED luminaire 11, 12, 13, 14 and its used lifetime and remaining expected lifetime, it is to be understood that a LED luminaire 11, 12, 13, 14 may comprise a combination of components that each can have different lifetime expectancy. For example, an LED driver might have a shorter lifetime as compared to a light engine, that is the LEDs themselves. Thus, in the case of a nonmodular solution the estimation of the LED luminaire lifetime is mainly defined by the component with the shortest life expectancy. The way that the LED luminaire 11, 12, 13, 14 is used, such as for instance how many power cycles have happened, will also impact different components differently. In case of a modular solution a situation when only some components of the second-hand LED luminaires are used, for example only an optical part that usually has a longer lifetime, may also be feasible.

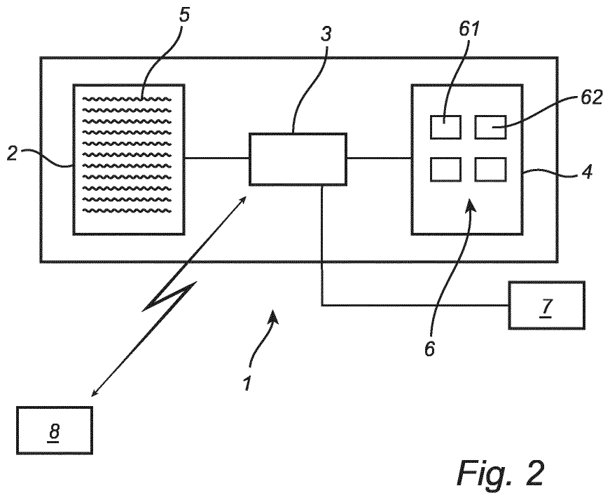

The code 21, 22, 23, 24 may for instance be a barcode or a smart-code. The code 21, 22, 23, 24 may be embedded in a chip. In any event, the code 21, 22, 23, 24 may be read by a suitable reading device 7 (cf. FIG. 2), such as a barcode reader or a smart-code reader or a chip reader.

FIG. 2 shows a schematic diagram of a system 1 according to the invention for determining a mounting pattern of a plurality of LED luminaires, such as the plurality of LED luminaires 10 shown in FIG. 1. Generally, and irrespective of the embodiment, the system 1 comprises a memory unit 2 and a processor 3.

The processor 3 is configured to obtain data comprising a used lifetime of a plurality of LED luminaires 10. The processor 3 is configured to store the obtained data 5 in the memory unit 2. The processor 3 is further configured to use the obtained data 5 to determine at least one of a used lifetime and a remaining expected lifetime of each LED luminaire 11, 12, 13, 14 of the plurality of LED luminaires 10. The processor 3 is further configured to determine a mounting pattern 6 of the plurality of LED luminaires 10.

The obtained data 5 thus comprises a used lifetime of some of or each LED luminaire 11, 12, 13, 14 of a plurality of LED luminaires 10. The obtained data 5 may further comprise a remaining expected lifetime of some of or each LED luminaire 11, 12, 13, 14 of the plurality of LED luminaires 10. The obtained data 5 may further comprise one or more of such further parameters as an expected renovation or refreshment time for a given location, and ease or difficulty of installing or changing a LED luminaire in the location.

The memory unit 2, the processor unit 3 and thus also the obtained data 5 may be located and the mounting pattern 6 may be determined and/or outputted 6 on a client side, such as on an installer's computer or smart tablet. Alternatively, it is also feasible that the memory unit 2, the processor unit 3 and thus also the obtained data 5 may be located at a remote location, such as on a cloud or server side, while the mounting pattern 6 may be determined and/or outputted 6 on a client side, such as on an installer's computer or smart tablet.

The information contained in the obtained data 5 may be retrieved from the code 21, 22, 23, 24 provided on each LED luminaire 11, 12, 13, 14 of the plurality of LED luminaires 10. To this end, the system 1 may further comprise a reading device 7 for reading the code 21, 22, 23, 24 provided on each LED luminaire 11, 12, 13, 14 of the plurality of LED luminaires 10. Alternatively, or additionally, the obtained data 5 may comprise data provided by the processor by modelling, for each LED luminaire 11, 12, 13, 14 of the plurality of LED luminaires 10 at least one of a used lifetime and a remaining expected lifetime based on a usage pattern of the LED luminaire and on environmental parameters.

The mounting pattern 6 is a pattern in which the LED luminaires 11, 12, 13, 14 of the plurality of LED luminaires may be mounted or installed. The mounting pattern 6 may comprise one or more groups 61, 62 of LED luminaires 11, 12, 13, 14. The one or more groups 61, 62 of LED luminaires 11, 12, 13, 14 is determined based on the determined one of the used lifetime and the remaining expected lifetime of each LED luminaire 11, 12, 13, 14 of the plurality of LED luminaires 10. Alternatively, or additionally, the mounting pattern 6 may comprise one or more locations in which to install the LED luminaires 11, 12, 13, 14 of the plurality of LED luminaires 10. The one or more locations is based on the determined one of the used lifetime and the remaining expected lifetime of each LED luminaire 11, 12, 13, 14 of the plurality of LED luminaires 10. If the mounting pattern 6 comprises both one or more groups 61, 62 of LED luminaires 11, 12, 13, 14 and one or more locations in which to install the LED luminaires 11, 12, 13, 14, the one or more locations may be based on the determined one of the used lifetime and the remaining expected lifetime of each LED luminaire 11, 12, 13, 14 of the respective group 61, 62 of the one or more groups of LED luminaires 11, 12, 13, 14. Further parameters on which the at least one location may be based include one or more of an expected renovation or refreshment time for the location, and ease or difficulty of installing or changing a LED luminaire in the location. Ease or difficulty of installing or changing a LED luminaire in a location may for instance be determined based on the height to the ceiling in the location(s). Another further such parameter may be the impact of one of the LED luminaires breaking, such as how quickly it must be replaced. By way of example, an LED luminaire breaking in an operating theatre or operating room or the like most likely needs to be replaced immediately while one LED luminaire breaking in a waiting room may more reasonably wait for a few days before replaced. Taking this parameter into account adds to minimizing the cost of replacement, since if an LED luminaire requires urgent replacement it will most likely be more expensive to wait with replacement especially due to the amount of time the space otherwise cannot be used due to lack of light.

The processor 3 is further configured to outputting the determined mounting pattern 6. For instance, the processor 3 may be configured to output the determined mounting pattern by at least one of presenting the determined mounting pattern 6 on a display 4 of the system 1, storing the determined mounting pattern 6 in the memory unit 2, storing the determined mounting pattern 6 in a memory unit 8 being external to the system, and providing installation instructions based on the determined mounting pattern 6.

The processor 3 may further optionally be configured to perform a periodic assessment of each LED luminaire 11, 12, 13, 14 of the plurality of LED luminaires 10. Based on the assessment the processor 3 may further provide a recommendation as to which groups 61, 62 require new LED luminaires 11, 12, 13, 14, in which locations second-hand LED luminaires could be still used based on the prevailing conditions or both.

The processor 3 may further optionally be configured to perform identification of any second-hand LED luminaires present amongst the plurality of LED luminaires 10. The identification may be performed based on the determined at least one of the used lifetime and the remaining expected lifetime of each LED luminaire 11, 12, 13, 14 of the plurality of LED luminaires 10. The processor 3 may in this case further be configured to determine the mounting pattern 6 of the plurality of LED luminaires 10, or each of the one or more groups 61, 62 of LED luminaires, based not only on the determined one of the used lifetime and the remaining expected lifetime of each LED luminaire 11, 12, 13, 14 of the plurality of LED luminaires 10, but also based on the identified second-hand LED luminaires. For instance, if for a given LED luminaire the used lifetime is larger than zero or the remaining expected lifetime is smaller than the remaining expected lifetime for an identical but unused LED luminaire, the LED luminaire in question may be identified as a second-hand LED luminaire.

The processor 3 may also further optionally be configured to use a smart algorithm to automatically calculates used lifetime or remaining lifetime or both of the at least one LED luminaire 11, 12, 13, 14 and optionally also to transmit the result to a database, such as a Cloud based database.

Finally, the processor 3 may further optionally be configured to compile the obtained data 5. The processor 3 may compile the obtained data 5 into a form being easier to manage and to retrieve particular data from. Such a form may for instance be a database or a list.

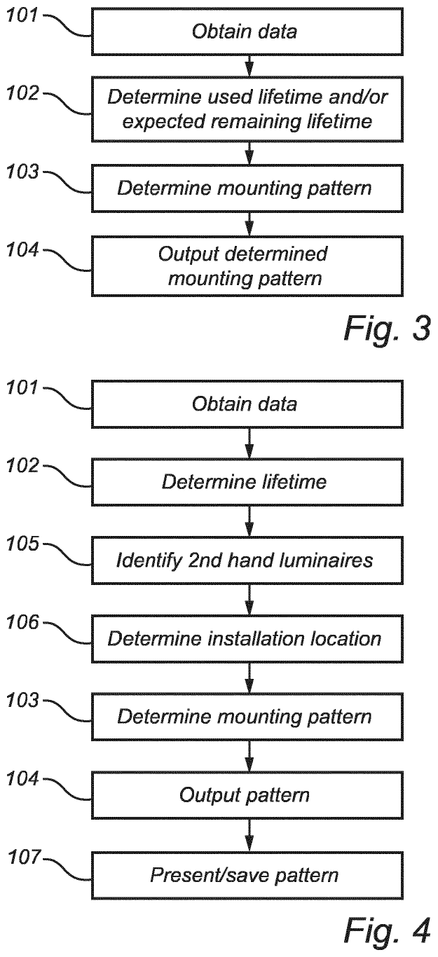

Turning now to FIG. 3, a flow diagram illustrating a method according to the invention is shown. Generally, and irrespective of the embodiment, the method according to the invention comprises the following four steps.

In a first step 101, data comprising at least a used lifetime of some of or each LED luminaire 11, 12, 13, 14 of a plurality of LED luminaires 10 is obtained and stored in a memory unit 2.

In a second step 102 at least one of a used lifetime and a remaining expected lifetime of each LED luminaire 11, 12, 13, 14 of the plurality of LED luminaires 10 is determined from the obtained data 5.

In a third step 103, a mounting pattern 6 of the plurality of LED luminaires 10 is determined. The mounting pattern 6 may be any type of mounting pattern as described above in relation to FIG. 2.

Finally, in a fourth step 104, the determined mounting pattern 6 is outputted.

FIG. 4 shows a flow diagram illustrating, in addition to the four steps 101-104 described above, three further possible and optional steps of a method according to the invention. The three further possible steps are the following.

A step 105 of identifying, based on the determined at least one of the used lifetime and the remaining expected lifetime of each LED luminaire 11, 12, 13, 14 of the plurality of LED luminaires 10, any second-hand LED luminaires amongst the plurality of LED luminaires 11, 12, 13, 14. In such a case the identification of step 105 may be taken into account when the mounting pattern 6 of the plurality of LED luminaires 10 or each of the one or more groups 61, 62 of LED luminaires 11, 12, 13, 14 is determined in step 103. Therefore, where included, step 105 may be performed before step 103 or as a sub-step of step 103.

A step 106 of determining at least one location in which to install each of the one or more groups 61, 62 of LED luminaires 11, 12, 13, 14 based on the obtained one of the used lifetime and the remaining expected lifetime of each LED luminaire 11, 12, 13, 14 of the respective group 61, 62 of the one or more groups 61, 62 of LED luminaires 11, 12, 13, 14. The determination of step 106 is at least based on the obtained data 5. The determination of step 106 may further optionally be based on one or more of an expected renovation or refreshment time for the location, and ease or difficulty of installing or changing a LED luminaire in the location. In such a case the determination of step 106 may be taken into account when the mounting pattern 6 of the plurality of LED luminaires 10 or each of the one or more groups 61, 62 of LED luminaires 11, 12, 13, 14 is determined in step 103. Therefore, where included, step 106 may be performed before step 103 or as a sub-step of step 103. Also, step 101 of obtaining data may optionally comprise obtaining on one or more of an expected renovation or refreshment time for a given location, and ease or difficulty of installing or changing a LED luminaire in the location.

A step 107 comprising one or more of presenting the determined mounting pattern 6, storing the determined mounting pattern 6 in the memory unit 2 or in an external memory unit 8, and providing installation instructions based on the determined mounting pattern 6. Where included step 107 is performed after step 104 or as a sub-step of step 104.

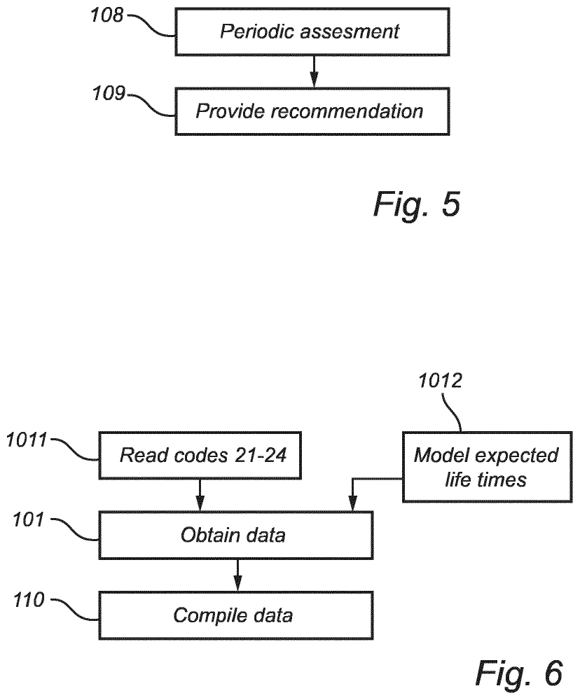

FIG. 5 shows a flow diagram illustrating two further possible steps of a method according to the invention.

In step 108, a periodic assessment of the at least one of a used lifetime and a remaining expected lifetime of each LED luminaire 11, 12, 13, 14 of the plurality of LED luminaires 10 is performed. In step 109 a recommendation is provided based on the assessment made in step 108. The recommendation is directed to at least one of which groups 61, 62 require new LED luminaires and in which locations second-hand LED luminaires could be still used based on the prevailing conditions. Where included steps 108 and 109 are performed after at least some of the remaining steps, particularly after step 104, of the method according to the invention. The periodic assessment of step 108 may be seen as a repetition of at least the above described steps 101 and 102.

FIG. 6 shows a flow diagram illustrating possible optional steps involved in obtaining data to be used by a system according to the invention and in a method according to the invention. The step 101 of obtaining data may comprise at least one of the following steps.

A step 1011 of retrieving information from a code 21, 22, 23, 24 provided on each LED luminaire 11, 12, 13, 14 of the plurality of LED luminaires 10. Step 1011 may for instance be performed by reading the codes 21, 22, 23, 24.

A step 1012 of, for each LED luminaire 11, 12, 13, 14 of the plurality of LED luminaires 10, providing at least one of a modeled used lifetime and a modeled remaining expected lifetime.

Step 101 of obtaining data may thus be based on the result of any one or both of steps 1011 and 1012, or any one or both of steps 1011 and 1012 may be performed as sub-steps of step 101.

Finally, FIG. 6 also shows an optional step 110 of compiling the obtained data 5. The obtained data 5 may be compiled into a form being easier to manage and to retrieve particular data from. Such a form may for instance be a database or a list. The step 110 of compiling the obtained data 5 may be performed at any time after step 101. If the step 110 of compiling the obtained data 5 is further performed before determining the mounting pattern 6 in step 103, a faster determination of the mounting pattern 6 may be obtained.

The person skilled in the art realizes that the present invention by no means is limited to the preferred embodiments described above. On the contrary, many modifications and variations are possible within the scope of the appended claims.

Additionally, variations to the disclosed embodiments can be understood and effected by the skilled person in practicing the claimed invention, from a study of the drawings, the disclosure, and the appended claims. In the claims, the word “comprising” does not exclude other elements or steps, and the indefinite article “a” or “an” does not exclude a plurality. The mere fact that certain measures are recited in mutually different dependent claims does not indicate that a combination of these measured cannot be used to advantage.

1. A system for determining a mounting pattern in which a plurality of LED luminaires comprising second-hand LED luminaires that have been retrieved from one or more previous lighting environments will be installed, the system comprising:
a memory unit and a processor, the processor being configured to:
obtain data comprising at least a used lifetime of each LED luminaire of a plurality of LED luminaires and store the obtained data in the memory unit,
determine, from the obtained data, at least one of the used lifetime and a remaining expected lifetime of each LED luminaire of the plurality of LED luminaires,
determine a mounting pattern of the plurality of LED luminaires, the mounting pattern comprising:
i) one or more groups of LED luminaires, the one or more groups of LED luminaires being determined based on the determined one of the used lifetime and the remaining expected lifetime of each LED luminaire of the plurality of LED luminaires, and
ii) at least one location in which to install the one or more groups of LED luminaires, the at least one location being based on the determined one of the used lifetime and the remaining expected lifetime of each LED luminaire of the respective group of the one or more groups of LED luminaires, such that LED luminaires with similar used lifetime and/or remaining expected lifetime are identified and installed in the same location, and
outputting the determined mounting pattern.

2. A system according to claim 1, wherein the processor is configured to further base the determination of the at least one location in which to install each of the one or more groups of LED luminaires on one or more of an expected renovation or refreshment time for the location, and ease or difficulty of installing or changing a LED luminaire in the location.

3. A system according to claim 1, wherein the obtained data further comprises any one or more of:
a remaining expected lifetime of each LED luminaire of the plurality of LED luminaires, and
information retrieved from a code provided on each LED luminaire of the plurality of LED luminaires, the code indicating at least one of a used lifetime and a remaining expected lifetime.

4. A system according to claim 1, wherein the system further comprises a reading device, and wherein the system is configured to read, by the reading device, a code provided on each LED luminaire of the plurality of LED luminaires, the code indicating at least one of a used lifetime and a remaining expected lifetime.

5. A system according to claim 1, wherein the processor further is configured to obtain the data by for each LED luminaire of the plurality of LED luminaires providing at least one of a modeled used lifetime and a modeled remaining expected lifetime, wherein the at least one of a modeled used lifetime and a modeled remaining expected lifetime are provided based on a usage pattern of the LED luminaire and on environmental parameters.

6. A system according to claim 1, the processor further being configured to any one or more of the following:
perform a periodic assessment of each LED luminaire of the plurality of LED luminaires, and based on the assessment provide a recommendation as to at least one of which groups require new LED luminaires and in which locations second-hand LED luminaires could be still used based on the prevailing conditions, and
identify, based on the determined at least one of the used lifetime and the remaining expected lifetime of each LED luminaire of the plurality of LED luminaires, the second-hand LED luminaires amongst the plurality of LED luminaires and determine the mounting pattern of the plurality of LED luminaires or each of the one or more groups of LED luminaires based on the determined one of the used lifetime and the remaining expected lifetime of each LED luminaire of the plurality of LED luminaires as well as the identified second-hand LED luminaires.

7. A system according to claim 1, wherein the processor further is configured to output the determined mounting pattern by any one or more of:
presenting the determined mounting pattern on a display of the system,
storing the determined mounting pattern in the memory unit,
storing the determined mounting pattern in a memory unit being external to the system, and
providing installation instructions based on the determined mounting pattern.

8. A computer implemented method for determining a mounting pattern in which a plurality of LED luminaires comprising second-hand LED luminaires that have been retrieved from one or more previous lighting environments will be installed, the method comprising:
by a computer processor:
obtaining data comprising at least a used lifetime of each LED luminaire of a plurality of LED luminaires and store the obtained data in a memory unit,
determining, from the obtained data, at least one of the used lifetime and a remaining expected lifetime of each LED luminaire of the plurality of LED luminaires,
determining a mounting pattern of the plurality of LED luminaires, the mounting pattern comprising:
i) one or more groups of LED luminaires, the one or more groups of LED luminaires based on the determined one of the used lifetime and the remaining expected lifetime of each LED luminaire of the plurality of LED luminaires, and
ii) at least one location in which to install the one or more groups of LED luminaires, the at least one location being based on the determined one of the used lifetime and the remaining expected lifetime of each LED luminaire of the respective group of the one or more groups of LED luminaires, such that LED luminaires with similar used lifetime and/or remaining expected lifetime are identified and installed in the same location, and
outputting the determined mounting pattern.

9. A method according to claim 8, wherein determining the at least one location in which to install each of the one or more groups of LED luminaires is furthermore based on one or more of an expected renovation or refreshment time for the location, and ease or difficulty of installing or changing the luminaire in the location.

10. A method according to claim 8, wherein obtaining data comprises at least one of:
obtaining data further comprising a remaining expected lifetime of the plurality of LED luminaires, and
retrieving information from a code provided on each LED luminaire of the plurality of LED luminaires, the code indicating at least one of a used lifetime and a remaining expected lifetime.

11. A method according to claim 10, wherein determining, from the obtained data, the at least one of the used lifetime and the remaining expected lifetime of each LED luminaire of the plurality of LED luminaires comprises, by the computer processor, reading the codes of the LED luminaires of the plurality of LED luminaires.

12. A method according to claim 8, wherein obtaining data comprises, for each LED luminaire of the plurality of LED luminaires, providing at least one of a modeled used lifetime and a modeled remaining expected lifetime, wherein the at least one of a modeled used lifetime and a modeled remaining expected lifetime are provided based on a usage pattern of the LED luminaire and on environmental parameters.

13. A method according to claim 8, and further comprising, by the computer processor, performing one or more of the following:
performing a periodic assessment of the at least one of a used lifetime and a remaining expected lifetime of each LED luminaire of the plurality of LED luminaires, and based on the assessment provide recommendation as to at least one of which groups require new LED luminaires and in which locations second-hand LED luminaires could be still used based on the prevailing conditions,
identifying, based on the determined at least one of the used lifetime and the remaining expected lifetime of each LED luminaire of the plurality of LED luminaires, the second-hand LED luminaires amongst the plurality of LED luminaires and determining the mounting pattern of the plurality of LED luminaires or each of the one or more groups of LED luminaires based on the determined one of the used lifetime and the remaining expected lifetime of each LED luminaire of the plurality of LED luminaires as well as the identified second-hand LED luminaires, and
outputting the determined mounting pattern by any one or more of: presenting the determined mounting pattern, storing the determined mounting pattern in a memory unit, and providing installation instructions based on the determined mounting pattern.
